(19) United States
(12) Patent Application Publication
(10) Pub. No.: US 2012/0254052 A1
(43) Pub. Date: Oct. 4, 2012

(54) ANTI-COUNTERFEITING MARKING WITH DUAL-CODE AND PARTIAL CONCEALMENT

(76) Inventors: ZeMing M. Gao, Portland, OR (US); Pingyi Yan, Shenzhen (CN)

(21) Appl. No.: 13/079,024

(22) Filed: Apr. 4, 2011

(51) Int. Cl. G06Q 10/00; G06K 19/06; B42D 15/00; G06K 5/00

(52) U.S. Cl. 705/318; 235/380; 235/494; 283/74

(57) ABSTRACT

An anti-counterfeiting method associates the first code with an article to be authenticated to identify the article, and associates a second code with the first code as a confirmation code to verify the first code. Both the first code and the second code are reproduced on the article. The reproduced first code is overt code while the reproduced second code is covert and concealed from normal viewing by a concealment means such as a scratch-off material. An authorized person (e.g., a consumer) is allowed to conditionally remove the concealment to reveal the covert code. The first code and the revealed second code are used to verify the authenticity of the product with a verification center. During the verification, the first code identifies the article, while the second code verifies the first code to test the authenticity of the associated article.

### BACKGROUND

Product counterfeiting is a large and ever worsening problem in today's world economy. Not only does counterfeiting cause hundreds of billion dollars of losses, it also poses a threat to the life quality and the life safety of consumers.

Many anti-counterfeiting methods have been used and proposed in the past and the present, including both legal/social solutions and technological solutions. Technological solutions range from holograms, mass serialization, RFID, and chemical and physical analytical tests. Of the available solutions, some do not offer effective anti-counterfeiting while others are too complicated and costly.

For example, mass serialization requires a unique identifier for each individual product item sold or delivered to consumers. The unique product identifier may be used to check the authenticity of the corresponding product item. This requires a massive effort at the system level and requires a broad standard to be established and enforced. In addition, although mass serialization may be effective on discouraging mass counterfeiting which makes identical product items with identical markings or labeling, it is not effective on making counterfeit products which bear verifiable product identifiers on each item. This is because with product identifiers on the genuine products easily readable, it isn't prohibitively difficult to gain access to product identifiers, even a large number of them, for use on counterfeit products.

To alleviate the above problem, one proposal is to conceal the product identifier using a scratch-off material, and let the consumer remove the scratch-off when purchasing the product in order to use the uncovered product identifier to verify the authenticity of the product. This method, however, has its own disadvantages. For example, the method requires the consumer to remove a large area of scratch-off material for each item purchased, causing an unpleasant consumer experience. The problem is especially prominent when a long product identifier is used to achieve a necessary level of identification, or a 2-D code is needed for product identification.

There is a need to develop better and more practical and convenient anti-counterfeiting methods.

### SUMMARY OF THE INVENTION

This patent application discloses an anti-counterfeiting method which takes advantage of a previously unrealized asymmetric nature between the amount of information that needs to be concealed to effectively discourage counterfeiting and the amount of information required for sufficiently identify an article such as a product. Specifically, the amount of information that needs to be concealed to effectively discourage counterfeiting can be far less than the amount of information that is required to sufficiently identify an article. As a result, it is unnecessary to conceal the entire product identification information in order to effectively prevent counterfeiting. Alternatively, it is possible to have two different codes of asymmetric sizes, one large and one small, used in combination for product identification and anti-counterfeiting respectively.

Two separate codes can be used in combination for this purpose, of which the first code is an overt code, and the second code is a covert code. In one embodiment, the first code alone is sufficient for identifying the article to be authenticated. The second code (the covert code) is only long enough to discourage counterfeiting but does not have to contain enough information to identify the product by itself. For the purpose of authenticity verification, the first code is used to identify the article, while the second code is used to verify the first code.

In one embodiment, the method associates the first code with the article, and associates the second code with the first code as a confirmation code to verify the first code. Both the first code and the second code are reproduced on the article to be authenticated. The concealment of the second code is done in a way to allow an authorized person to uncover the concealed second code on or in the article to completely reveal the second code. The removing of the concealment is invasive enough to leave a sign indicating that the concealment has been removed.

In one embodiment, an authorized person such as a consumer to whom the second code has been revealed sends the first code and the second code to a verification center, which compares the received first code and second code with article code records stored in the data storage, and verifies to the authorized person that the product is authentic if the received first code and second code find a match in the article code records stored in the data storage. The communication between the authorized person and the verification center may be carried out in a variety of ways, including a telephone by voice, a telephone to dial in numbers, a wireless phone using short messaging, an application on a computer, a mobile application platform, and Internet-based user interface. An application program run on a computer or a mobile phone may have a preconfigured connection with a verification center, and once initiated, does not require the consumer to enter a phone number or URL address to connect to the verification center.

In another embodiment, the verification center receives the first code only but not the second code. Upon receiving the first code, the verification center checks against the product code records saved in the data storage to identify the code record associated with the product identified by the first code. The verification center then sends the second code associated with the identified first code back to the authorized person, who then checks the received second code against the second code revealed on or in the product to determine if the two codes match.

A would-be counterfeiter cannot easily remove the concealment to reveal second code without damaging the intact status of the code on the product. As a result, the only way to counterfeit the product code is to guess the concealed second code. If the counterfeiter makes a counterfeit product bearing such a guessed code, the counterfeit product runs the risk of being detected and rejected in the market. The guessing is thus not merely a costless intellectual act, but a costly endeavor to be practiced.

On the other hand, it is discovered that even a very small covert code can have a meaningful anti-counterfeiting effect. An advantage of having a relatively small covert code is that it does not cause a significant inconvenience for authorized persons to reveal the covert code. For example, a mere two-digit code would have one hundred possibilities. A counterfeit product bearing a randomly guessed two-digit code would only have a 1% of a chance to have the correct code and a 99% of a chance to have a wrong one. If the counterfeiter is to make a hundred counterfeiter products to statistically guarantee one success, he runs the risk of having ninety nine out of the hundred detected as a counterfeit and rejected in the market. This creates a large penalty factor and causes a heavy burden on the counterfeiter, and turns the economics against the counterfeiter, while at the same time does not create a heavy burden on the authorized persons.

Furthermore, multiple concealed codes may be used to offer multiple opportunities to verify the authenticity of the product. For example, two separate covert codes may give two separate opportunities of verification, one used by the original purchaser at the retailer, the other by the recipient of the product as a gift from the original purchaser at another occasion.

The method disclosed herein can be used with a variety of code schemes, including plain human-readable codes, encoded machine-readable codes, one-dimensional codes, and various two-dimensional codes. When two-dimensional codes are used, multiple covert code regions may be positioned at different corners of the two-dimensional code to add clarity and convenience.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the reference numbers which are identical except for the leading figure digit(s) in different figures indicates similar or identical items.

FIG. 1 shows a flow process of the first exemplary embodiment of the anti-counterfeiting method in accordance with the present disclosure.

FIGS. 2A-2C show an exemplary anticounterfeiting code used in the first exemplary embodiment of the anti-counterfeiting method.

FIG. 3 shows a flow process of the second exemplary embodiment of the anti-counterfeiting method.

FIGS. 4A-4D show an exemplary anticounterfeiting code having multiple covert code regions used in the second exemplary embodiment of the anti-counterfeiting method.

FIGS. 5A-5D show an exemplary anticounterfeiting code using a 2-D code.

FIGS. 6A-6C show an exemplary anticounterfeiting code using a mix of a barcode and an alphanumerical code.

### DETAILED DESCRIPTION

The anti-counterfeiting method is disclosed in further detail below using several exemplary embodiments with reference to various figures. In this description, the order in which a process is described is not intended to be construed as a limitation, and any number of the described process blocks may be combined in any order to implement the method, or an alternate method.

A typical anti-counterfeiting process involves a manufacturer, a retailer and a consumer, and possibly also other parties such as a shipping company and a distributor. However, anti-counterfeiting process may also involve a non-retailing process, such as a banking or government transaction involving documents, bills or checks that need to be authenticated. In the exemplary embodiments of this detailed description, a product is described as the object of authentication by a buyer or consumer. Such description is not meant to be restrictive but only illustrative. The product can be any article that needs to be authenticated, while the consumer may be any user or authorized person that desires the authentication of the article. In addition, although in the exemplary processes of this description a manufacturer acts to exercise the anti-counterfeiting method, it is understood that another party such as an anti-counterfeiting service provider may be an actor to exercise the anti-counterfeiting method.

Disclosed herein is an anti-counterfeiting method which, in one embodiment, is carried out according to the following procedure. The manufacturer assigns a product code to a product and stores the product code in a data storage. The manufacturer reproduces the product code on the product in a hybrid covert-overt fashion such that the reproduced product code has an overt code and a covert code. An authenticity verification center receives the overt code and the covert code from an authorized person (e.g., a consumer) who has revealed the covert code, and compares the received overt code and the covert code with the product code stored in the data storage. The verification center verifies to the authorized person that the product is authentic if the received overt code and the covert code match the product code stored in the data storage.

According to the disclosed method, as long as the covert code cannot be easily reproduced on another product by an unauthorized party, the above method will have an anti-counterfeiting effect.

There may be various ways to make the covert code difficult to be reproduced on another product by an unauthorized party. One method is to block the covert code from normal viewing and require an invasive act to gain access to the blocked covert code. If the invasive act causes sufficient damages which cannot be easily restored, it would render the product that had the original product code unsellable. This way, even if the unauthorized party may be able to reproduce the product code on a counterfeit product, the act has rendered the original product unsellable, at least causing a significant economic burden, and perhaps even defeating the purpose of counterfeiting itself.

A second method is to encrypt the covert code reproduced (e.g., printed) on a medium. The encryption is done in a way so that the covert code may be decrypted using a cipher, but the covert code itself cannot be easily reproduced again on another product by an unauthorized party even if the unauthorized party has access to the original product itself.

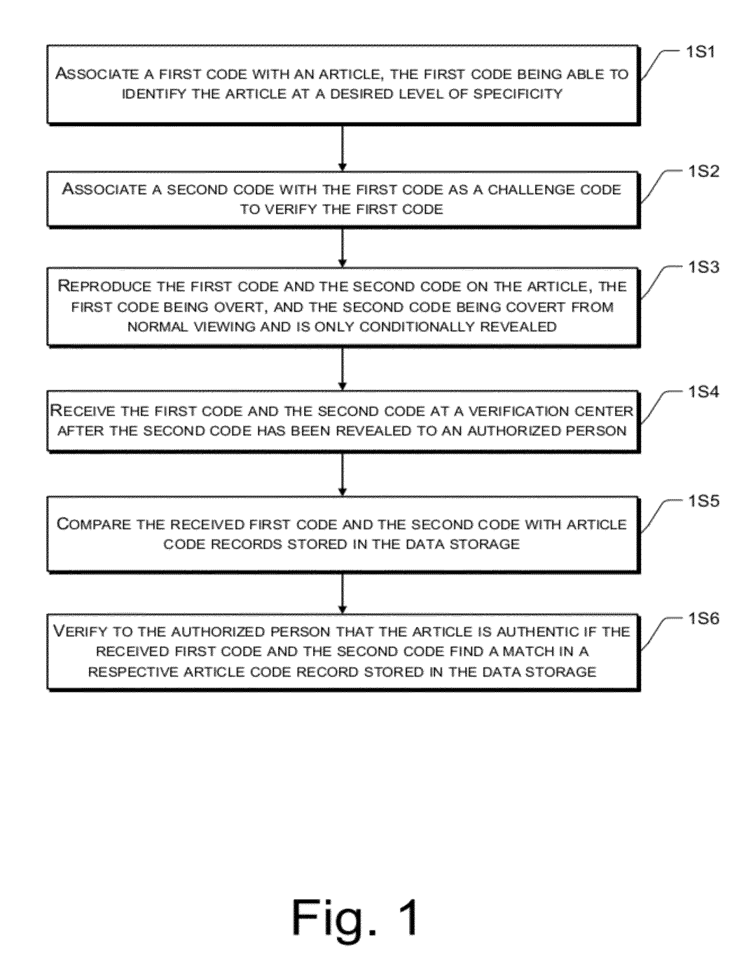

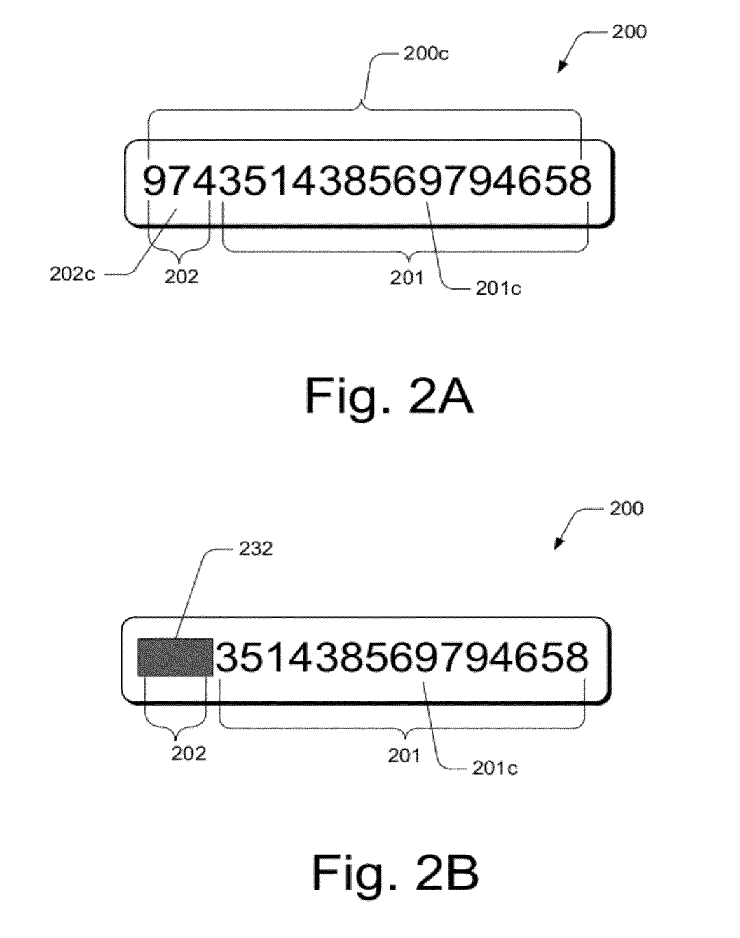

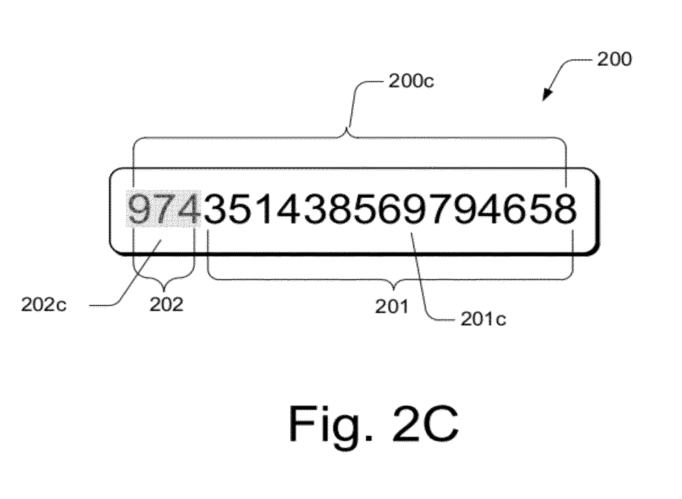

A first exemplary embodiment of the disclosed anti-counterfeiting method is illustrated in reference to FIG. 1 and FIGS. 2A, 2B and 2C. FIG. 1 shows a flow process of the first exemplary embodiment of the anti-counterfeiting method.

At Block 1S1, the manufacturer assigns a product code to a product. This involves associating a product-identifying code with the product. The product code can be any type of a code that is sufficient to identify the product. Different manufacturers may need various levels of product identification. At a very low level, the product code may only be able to identify a certain product type or model. But in order to offer sufficiently effective anti-counterfeiting, higher level of specificity of the product identification is preferred. For example, the product code preferably uniquely identifies a production batch of the same product, and more preferably uniquely identifies a package of the same product, and still more preferably uniquely identifies each separate product as an individual piece. If the manufacturer, or the anti-counterfeiting service provider, participates in a standard body for mass serialization, the product code assigned may not only be product-specific among other products of the same manufacture or the same industry, but also be product-specific among all products in the commerce that participate in the mass serialization standard.

It is appreciated that the product code may be in an human-readable form, such as plain numbers, or alphanumerical combinations, but may also be a machine-readable form such as information that is only visible to special readers (either non-encoded or encoded), or encoded information that requires a special reader with a matching decoder to read. It is also appreciated that either linear codes (1D codes) such as 1D barcodes, or 2-D (matrix) codes such as QR codes and Microsoft Tags may be used.

FIG. 2A shows an exemplary product code used in accordance with the present disclosure. Product code 200c, which is a plain numerical code in the illustrated embodiment, is positioned on product tag 200, which has a first code region 201 containing a first code 201c, and a second code region 202 containing a second code 202c. The first code 201c and the second code 202c together make up a longer code 200c.

In one embodiment, the first code 201c alone serves as a products-identifying code, and is associated with the product. The product code 201c may be any alphanumerical code, such as a serial number, or a graphical code such as a barcode, generated to identify a product.

At Block 1S2, the manufacturer associates the second code 202c with the first code 201c as a confirmation code to verify the first code 201c. The second code 202c is added as a confirmation code to discourage counterfeiting in association with the product-identifying first code 201c. More specifically, the first code 201c is created as a product-identifying code and associated with a product to identify the product, while the second code 202c is generated separately and assigned to the first code 201c as a confirmation code in association with the first code 201c.

The second code 202c is not required to be able to uniquely identify the first code 201c or the product and therefore can be significantly shorter than the first code 201c. It is permissible that the second code 202c associated with several different first codes 201c of different product items may happen to have the same value and still able to offer an effective anti-counterfeiting effect. To be effective as an anti-counterfeiting measure, however, it is preferred that the second code 202c cannot be calculated or predicted from the first code 201c. One way to make the second code 202c unpredictable is to generate it as a random number.

The first code 201c and the second code 202c may be either generated and managed as parts of a single product code 200c, or separately generated and managed as two different codes associated with the same product. Separately generating the first code 201c may help avoiding redundancy of the first code 201c. The first code 201c independently serves as a product-identifying code which can be submitted for a verification or informational purpose. The two separately generated codes are combined together subsequently for product authenticity verification, as shown below.

However, in an alternative embodiment, the combined product code 200c may serve as a product-identifying code if the first code 201c does not sufficiently identify the product. That is, only the combined product code 200c uniquely identifies the product to which the product tag 200 is attached, and neither the first code 201c nor the second code 202c is created to be a unique product identifier. Even so, the first code 201c is preferably at least sparsely used among the products, meaning that only just a few products share the same first code 201c. As will become clear with the description herein, this sparsity helps to maintain the effectiveness of the anti-counterfeiting measure. In general, if there is a high level of redundancy for the code 201c in the first code region 201, many products that have a different code 202c may share the same code 201c, and as a result randomly guessing a code for the second code 202c would have a higher chance to match one of the genuine products made by the manufacturer, rendering the anti-counterfeiting measure less effective.

At Block 1S3, the manufacturer reproduces the first code (201c) and the second code (202c) on the product that can benefit from the anti-counterfeiting measure. This can be done in a variety of ways on a variety of products. Any practical means that suits the manufacturer's requirements may be used. For example, the product may be any kind of merchandise that potentially suffers the threat of counterfeiting. The examples include a drug, a branded liquor product, wine, cigarettes, clothes, food, supplements, a tool, a document, etc. The reproduction of the product code may be done in any practical way. In general, however, the reproduced product code should preferably not be easily removed without causing a detectable damage or change to the reproduced product code and/or the product itself. If the product is contained in a packaging such as a box or a bottle, it is also generally preferred that the product contained in the packaging cannot be easily removed from the packaging without causing a detectable damage or change to the reproduced product code.

The product code may be printed on a separate label or tag of a suitable material and affixed to the product, but may also be printed or produced on the product itself if practical. In the present description, the term “product tag” may refer to any of these situations and does not necessarily suggest that physically separated or separable item. It is noted that reproducing the product code on the product does not mean that the product is necessarily made first, and the product code is reproduced on the product subsequently. The product and the product code may be made in a single manufacturing process.

When reproducing the first code and the second code on the product, manufacturer conceals the second code region on the product. An example of such concealment is illustrated in FIG. 2B where the second code 202c is blocked from normal viewing. Any suitable method may be used to accomplish such concealment. The goal is to cover the code 202c in the second code region 202 and make it invisible under normal conditions. At the same time, it is preferred that the concealment may be fairly easily removed for product authenticity check without requiring a special tool. To effectively guards against counterfeiting, the concealment should only be removable at least partially invasively, and once removed, should not be easily restored without leaving any visible marks to indicate that the concealment has once been removed to reveal the code 202c. The invasiveness at least partially damages or permanently alters the concealment such that it cannot be easily restored to its original condition.

One suitable method to achieve this goal is applying a scratch-off layer 232 over the second code region 202 to cover the second code 202c. The scratch off layer 232 can be fairly easily scratched off without using a special tool to reveal the code 202c, and at the same time cannot be easily restored to cover the region again. An alternative is to use a layer of material that can be peeled off.

It is noted that the first code 201c and the second code 202c do not have to be reproduced in the same area, or the same tag, but can be reproduced at different areas or different parts and locations on the product. Particularly, it is conceived that the first code 201c may be displayed in an exterior part of the product or product packaging, while the second code 202c may be hidden in an area which is accessed only when the product packaging is opened. For example, the first code may be printed on an exterior surface of a box packaging, while the second code may be placed inside the box and accessible only after the box is opened. The first code may be printed on an exterior surface of a bottle packaging, while the second code may be placed or printed on the inner surface of a cap or lid close in the bottle.

At Block 1S4, the verification center receives the first code and the second code after the second code has been revealed to an authorized person (such as a consumer). The concealed second code 202c is conditionally revealed to an authorized person. The conditional revealing of the second code 202c requires physical access to the product. It also requires the concealment over the second code 202c to be at least partially invasively removed to uncover the concealed second code region 202 on the product. In the illustrated embodiment, the concealment is a scratch-off layer 232. As the authorized person gains physical access to the product, he may be allowed to manually remove the scratch-off layer 232 to reveal the second code 202c. Once the covert second code 202c is revealed, the entire product code 200c is visible to the authorized person.

Alternatively, at Block 1S4, the verification center may receive the first code 201c only but not the second code 202c. Upon receiving the first code, the verification center checks against the product code records saved in the data storage to identify the code record associated with the product identified by the first code. The verification center then sends the second code associated with the identified first code back to the authorized person, who then checks the received second code against the second code revealed on or in the product to determine if the two codes match. If they don't match, it would indicate a counterfeit product. If they do match, it is an indicator that the product is likely to be genuine. This method essentially has an element to check not only the genuineness of the product, but also the legitimacy of the verification center, because it is possible that a counterfeit product may have provided information that guide the consumer to contact a bogus verification center which would always send out an affirmative answer for verification. However, this method also has a potential disadvantage as a counterfeiter might use the overt code (the first code) to harvest the covert code (the second code). In addition, without the input of the covert code (the second code) from the consumer side, the verification center would also have a difficult time to keep a record of the number of times the product has been successfully verified as it would be difficult to determine whether each request of verification was a success or not. This alternate method, therefore, may be more useful if used for a subsequent or secondary verification in a design which has multiple covert codes for multiple verifications, as described below.

FIG. 2C shows an example of the product code 200c after the concealment has been removed. In the illustrated embodiment, the concealment is a scratch-off layer 232. After the authorized person has removed the scratch-off layer 232, the code 202c is revealed, and the authorized person is able to read the complete product code 200c on the product tag 200.

The authorized person to whom the second code has been revealed sends the first code and the second code to a verification center. The communication between the authorized person and the verification center may be carried out in a variety of ways, including a telephone by voice, a telephone to dial in numbers, a wireless phone using short messaging, a mobile application platform, and Internet-based user interface.

At Block 1S5, the verification center compares the received first code 201c and second code 202c with article code records stored in the data storage for a possible match. Typically, the manufacturer or the anti-counterfeiting service provider has a data storage to keep a large number of article code records (product codes) that are associated with large number of products or product items.

At Block 1S6, the verification center verifies to the authorized person that the product is authentic if the received first code 201c and second code 202c find a match in a respective article code record stored in the data storage. Usually, the verification center has access to a data storage where a large number of product codes are stored. One way to perform matching by comparison is to search through the records of the product codes stored in the data storage to match the received codes 201c and 202c against the stored product code 200c. The received codes 201c and 202c may be combined as a single code to match the stored product code 200c, or treated as two separate codes to match against the respective code segments in the stored product code 200c. If there is a match, the verification center may send out an affirmative verification.

In a preferred embodiment, the verification center has a mobile communication center. The codes 201c and 202c are sent by the authorized person using a mobile device such as a cell phone to the verification center, which then returns the message of verification to the mobile device of the authorized person. This two-way communication may be done using simple text messaging such as SMS.

In another embodiment, the verification center is a call center which receives the codes from the authorized person over telephone. The codes may be provided either by voice or entered through a keypad on the telephone. Call-center may either have human operators or automatic voice processing.

The verification center may also send to the authorized person other information related to the product being verified at the time of verification. Examples of such information include prices, store locations, ratings of the product, coupons, or recommendation of related products.

To discourage counterfeiters from using real product codes recycled from used products, the verification center may keep records for the past verifications, and either reject a call for verification or send out a warning when the received product code has already been used for verification once or more in the past.

It is noted that in the above illustrated embodiment, the first code 201c and the second code 202c are sent to the verification center together. Alternatively, each of the first code 201c and the second code 202c may be separately submitted for a respective type of verification or informational purpose. For example, the first code 201c may independently serve as a product-identifying code which can be submitted for a verification or informational purpose without combining with the second code 202c. This can be performed before the concealment over the second code region 202 is removed to reveal the second code 202c.

Even if the overt code 201c alone may not provide a high level of confidence for authenticity without combining with the code 202c, it may nevertheless be informative before the authorized person is committed to the product by removing the scratch-off 232. For example, suppose the overt code 201c alone uniquely identifies the product at individual product item level in the system (which may or may not require mass serialization). Upon receiving from the authorized person the overt code 201c to the verification center, the system may inform the authorized person whether this product has been verified before, and further how many times. If the system discovers that the particular product item has already been checked and verified by receiving from a previous authorized person the combined code 200c, it may indicate a high likelihood that the particular product item is a counterfeit, and the authorized person (e.g., a consumer) would have learned this information before committing to the product and removing the concealment material over the covert code 202c.

However, if the system has no record of such verification in the past for this particular product item, the authorized person may desire a higher level of confirmation by committing to the product and to be allowed to reveal the covert code 202c. The higher level of confirmation may be desired because the mere “no record” status may not necessarily prove that the particular product item is genuine. It is possible that both a genuine product item and one or more counterfeit products bearing the identical overt code 200c may exist in the market, and the genuine product item has not been sold yet. In this scenario, the product item checked by the authorized person could be either genuine or fake, and the authorized person will need to reveal the covert code 202c to further confirm.

In addition, the overt code 201c may be separately used to obtain other product related information which may be helpful even without offering a high-level confidence of authenticity of the particular product item.

In another embodiment, the overt code 201c may only offer to identify the product on other levels such as batch level, or product type level, instead of at an individual product item level. Such identification information may be used for purposes such as consumer assistance without requiring a commitment to the particular product item.

As shown above, the anti-counterfeiting method disclosed herein reproduces the product code on the product in a hybrid covert-overt fashion such that the reproduced product code has an overt product-identifying code (201c) and a covert confirmation code (202c). The overt code may serve as a complete product-identifying code, while the covert code serves for challenging the validity of the overt code and discourage counterfeiting. Alternatively, the overt code and the covert code may be a subset of the product-identifying code (200c).

In one embodiment, the covert code 202c is substantially smaller than the complete product-identifying code (e.g., 201c). It is discovered that the amount of information that needs to be concealed from a potential counterfeiter to effectively discourage counterfeiting can be far less than the information that is required to sufficiently identify a product. Thanks to this asymmetric nature between the counterfeit-hampering information and the product-identifying information, only a relatively small part of the product code needs to be concealed as counterfeit-hampering covert code 202c.

In the example shown FIGS. 2A, 2B and 2C, the covert code 202c has only three digits. When these three digits are concealed from normal viewing and can only be invasively revealed, they create odds of one out of a thousand for a randomly guessed number to match the concealed covert code 202c. This means that if a would-be counterfeiter wants to statistically guarantee that at least one of its counterfeit products can pass the anti-counterfeiting verification, the counterfeiter will have to make a thousand such counterfeit products with all other nine hundred ninety nine facing rejection by the anti-counterfeiting verification. This creates a huge burden for counterfeiting and would make it unprofitable for counterfeiting virtually anything in the commerce. For ordinary products, even an odd of one out of ten created by a single-digit covert code may be a sufficient anti-counterfeiting measure. If alphabetical letters or other symbols are used in the product code instead of just numbers, the odds can be even smaller. For counterfeiters who are used to unrestrained and unburdened counterfeiting, this is already a dramatic increase of burden.

The discovery that only a small part of the product code needs to be concealed in order to hamper counterfeiting makes the anti-counterfeiting method of the present disclosure easy to implement. According to the prior art, removing the concealment of a long or large code can be a hassle for a consumer to do. Scratching off a covering of a long string of numbers, for example, is often not only time-consuming but also an unsightly and messy one. If a 2-D product code is used, it may result in even greater inconvenience and may prove to be too consumer-unfriendly to be implemented.

With the anti-counterfeiting method disclosed herein, however, the code region that needs to be concealed may only occupy a fraction (e.g., less than one half, less than one quarter, or even smaller) of the area which is occupied by the product code as a whole. If the part of the product code that needs to be construed is alphanumerical, only one and up to six alphanumerical positions may provide an effective anti-counterfeiting measure.

It is noted that the effectiveness of the anti-counterfeiting method disclosed herein does not require a technological impossibility or even a real hardship for restoring the concealment. As long as the method makes it more difficult for a would-be counterfeiter to make counterfeit products, it has an anti-counterfeiting effect. When no anti-counterfeiting measure is implemented, a counterfeiter can freely make a counterfeit product with an arbitrary label that just visually appears similar to the product code of the manufacturer. When only an overt product-identifying code is used for anti-counterfeiting, the counterfeiter may be discouraged from using arbitrary product codes, but may still have relatively easy access to a large number of genuine product codes and use them to make counterfeit products which would have little problem with the anti-counterfeiting measure. In comparison, when at least a part of the product code is concealed, the counterfeiter will need to have real physical control over the product in order to gain access to the concealed product code. If the uncovering of the concealed code is further necessarily invasive to result in damaging or altering of the product code and/or the product, the counterfeiter would not only have to have physical control over the product, but will also run risk of rendering the real product unsellable in order to make a counterfeit product.

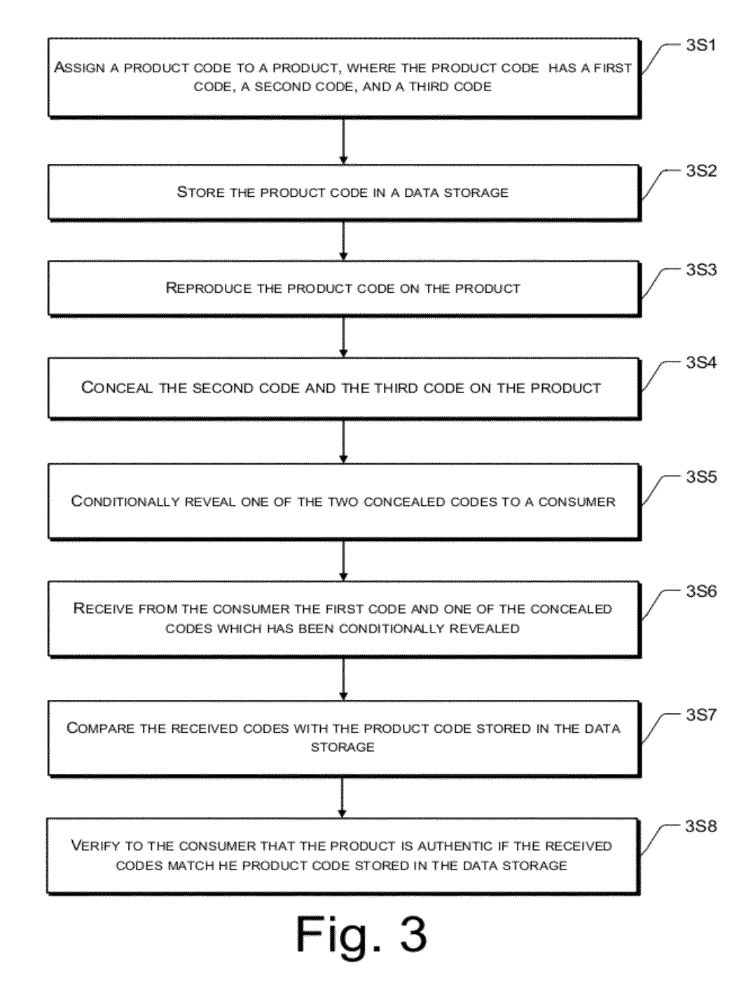

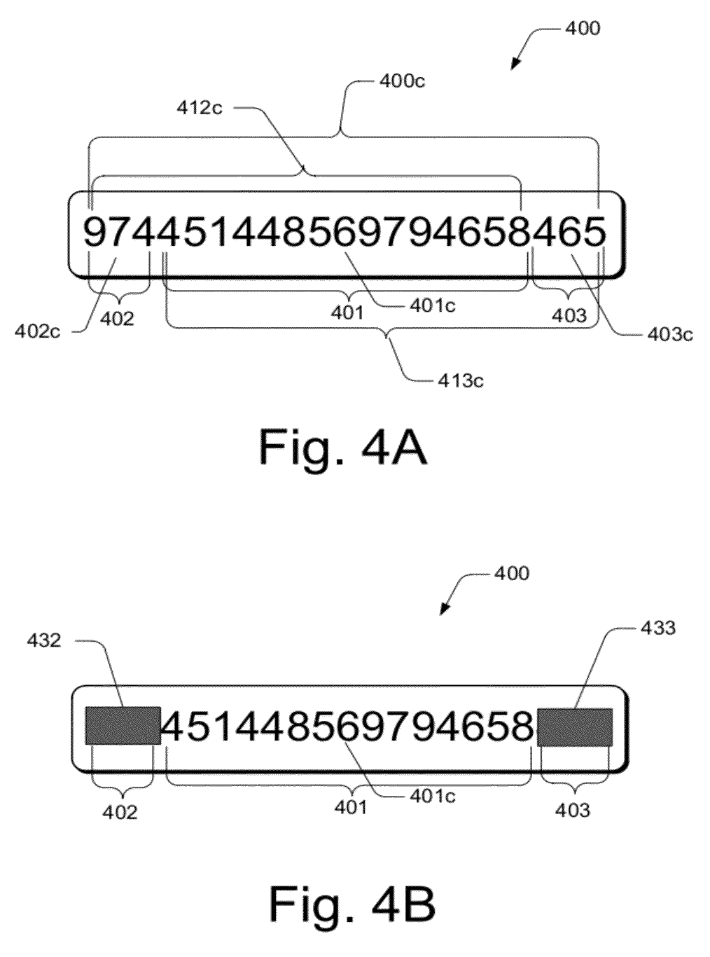

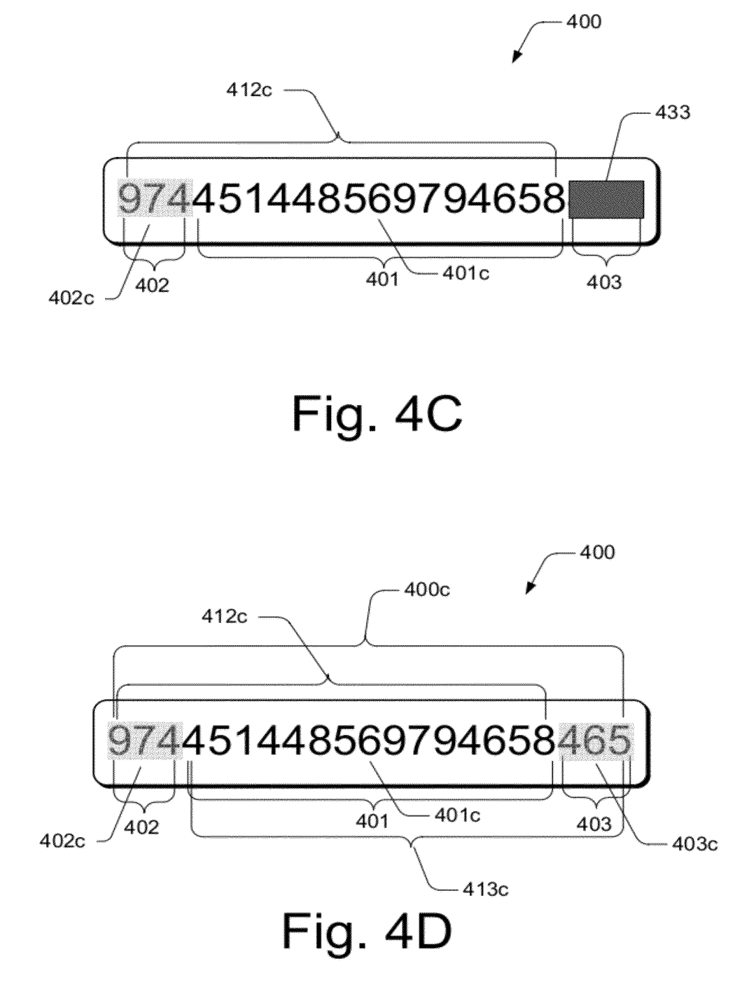

A second exemplary embodiment of the disclosed anti-counterfeiting method is illustrated in reference to FIG. 3 and FIGS. 4A, 4B, 4C and 4D.

FIG. 3 shows a flow process of the second exemplary embodiment of the anti-counterfeiting method. The second exemplary embodiment differs from the first exemplary embodiment in that here the product code has two concealable regions to make two covert codes instead of just one.

At Block 3S1, the manufacturer assigns a product code to a product. FIG. 4A shows an exemplary product code used in the second exemplary embodiment of the anti-counterfeiting method. The product code 400c is positioned on product tag 400, which has a first code region 401 containing a first code 401c, a second code region 402 containing a second code 402c, and a third code region 403 containing a third code 403c.

When reproduced on the product, each of the second code region 402 and the third code region 403 are concealed. The combination of two concealed codes provides further flexibility to the method.

In one embodiment, the first code 401c is either unique for each product or at least sparsely used among the products, meaning that only one or just a few products share the same code 401c. The first code 401c may be generated separately from the second code 402c and the third code 403c, and the three codes are combined together subsequently. This helps to manage the redundancy of the first code 401c.

Further, if the first code 401c is capable of identifying the product with a sufficient level of specificity (e.g., at individual product item level), it alone may be used as a product-identifying code associated with a product. Correspondingly, the second code 402c and the third code 403c can be small or short codes each serving as a challenging code to verify the product-identifying code 401c.

In terms of the code structure, the first code 401c and the second code 402c together constitute a first combined code 412c; the first code 401c and the third code 403c together constitute a second combined code 413c; and the first code 401c, the second code 402c, and the third code 403c together constitute a third combined code 400c. In one embodiment, any of the combined codes 412c, 413c and 400c is capable to uniquely identify the product to which the product tag 400 is attached. Additionally or alternatively, the first code 401c is capable to uniquely identify the product, and the second code 402c and the third code 403c are added only to provide anti-counterfeiting in association with the product-identifying code 401c.

At Block 3S2, the manufacturer stores the product code (e.g., product code 400c including the first, the second and the third codes 401c, 402c, 403c) in a data storage (not shown).

At Block 3S3, the manufacturer reproduces the product code on the product that can benefit from the anti-counterfeiting measure.

At Block 3S4, the manufacturer conceals the second code 402c and the third code 403c on the product. An example of such concealment is illustrated in FIG. 4B where the second code region 402 and the third code region 403 are concealed from normal viewing by a scratch-off layer 432 and a scratch-layer 433 respectively. The scratch-off layers 432 and 433 can be fairly easily scratched off to reveal the second code 402c and the third code 403c, and at the same time not easily restored to cover the region again. As shown, the concealed regions 402 and 403 are preferably separated from each other in order to be clearly viewed as two separate sections serving different purposes. As will be shown below, each concealed region can be used for a separate occasion for verification by a different person.

At Block 3S5, one of the concealed code 402c and 403c is conditionally revealed to an authorized person. FIG. 4C shows an example of the product code 400c with the one of the covert codes revealed. After the authorized person has removed the scratch-off layer 432, the code 402c in the second code region 402 is revealed, and the authorized person is able to read the first combined code 412c which is a combination of the first code 401c and the second code 402c. Alternatively, the authorized person may remove the scratch-off layer 433 at this step to reveal the third code 403c and the respective combined code 413c which is a combination of the first code 401c and the third code 403c.

At Block 3S6, a product authentication verification center receives from the authorized person the first code 401c and the second code 402c.

At Block 3S7, the verification center compares the received first code 401c and the second code 402c with the product code stored in the data storage for a possible match. The match can be either done for the combined code 412c as a single code, or separately for each of the first code 401c and the second code 402c.

At Block 3S8, the verification center verifies to the authorized person that the product is authentic if the received first code 401c and the second code 402c match the product code stored in the data storage. At this stage, for example, because the authorized person may have scratched off any one of the two concealed code areas 402 and 403, a search at the data storage where the product codes are stored may match the first code 401c with the first code in the stored product code, and match the received second code 402c with any one of the second code and the third code in the stored product code. These stored codes (the first code, the second code and the third code) may be kept as separate records but are associated with the same product, or kept as different data segments of a single record. The storage scheme may affect the search scheme, but any suitable method may be used and the manner of data storage and search is not an essence of the present disclosure.

Unlike the first embodiment of the anti-counterfeiting method in which each product has just one product-identifying code, here, each product may have multiple product-identifying codes to be matched. The first code 401c alone, or each combined code 412c, 413c or 400c may serve as a product-identifying code.

In one embodiment, the first code 401c alone may serve as a product-identifying code, and may be submitted for a verification or informational purpose without combining with one of the second code 402c and the third code 403c, as described in relation to overt code 201c in the product code 200c. This can be performed before the concealment over the second code region 402 is removed to reveal the second code 402c. However, if the system has no record of such verification in the past for this particular product item, the authorized person may desire a higher level of confirmation by committing to the product and to be allowed to reveal one of the covert codes 402c and 403c.

FIG. 4D shows an example where the product code 400c is used for a second verification opportunity. After the first authorized person (e.g., a consumer) has done verification, one of the two concealed code regions 402 and 403 still remains concealed and may be used to offer a second opportunity for product authenticity verification. In the present case, the third code region 403 remains concealed as shown in FIG. 4C.

A second authorized person (e.g., a second consumer) may remove the scratch-off layer 433 to reveal the third code 403c, and correspondingly reveal an alternate product-identifying code 413c which can be used for product authenticity verification in a manner similar to how the first authorized person has used the product-identifying code 412c for authenticity verification. At this point, however, the entire product code 400c is visible to the second authorized person. Instead of using the first code 401c or the combined code 413c, which need to be carefully selected, as the product-identifying code, it may be more convenient for the second authorized person to use the complete product code 400c as a product-identifying code for authenticity verification. It is a matter of design choice to use either or both of these product-identifying codes for authenticity verification.

Furthermore, when the second authorized person submits the codes for verification, the verification center would already have a record for a successful verification conducted by the first authorized person. It is preferred that the system at the verification center is designed to be able to distinguish a second submission by the second authorized person from a first submission by the first authorized person in order to provide more accurate information to the consumers. One way to do this is to receive the first code 401c and the second code 402c or the third code 403c as separate codes and their relative positions noted. Another way to make this distinction is for the system to note the total size of the code submitted. In the illustrated example of product code 400c, for example, the first time submission has a total combined code of 18 digits (code 412c), while the second time submission can be designed to have a total combined code of 21 digits (code 400c). In any event, if the system already has a record of two successful verifications in the illustrated example, it can determine that there is a high likelihood that the product is a counterfeit.

Alternatively, in the second verification, the verification center may receive the first code 401c only (or the first code 401c and the second code 402c only) but not the third code 403c. Upon receiving the first code (or the first code and the second code), the verification center checks against the product code records saved in the data storage to identify the code record associated with the product identified by the first code. The verification center then sends the third code associated with the identified first code back to the second authorized person, who then checks the received third code against the third code revealed on or in the product to determine if the two codes match. This method helps to check the legitimacy of the verification center. In addition, because the second verification happens only after the first authorized person has already checked the authenticity of the product using the one of the covert codes (the second code), it prevents a counterfeiter from using the procedure for the second verification to fish for covert codes of the product.

The second chance for verification described above may be useful in occasions where there is a return by the first authorized person and a subsequent authorized person who buys the returned product may still have a separate opportunity to verify the authenticity of the product. In addition, the revealed status of the first covert code also provides evidence that the product is a return, and the subsequent authorized person may only want to buy it with a discount. This therefore also provides protection to consumers from unknowingly buying returned products. The second verification chance may also be useful when the product is bought by the first consumer who performed the verification at the retail place, and subsequently gives the product to another person as a gift. In this case, the recipient of the gift would have an independent chance to verify the authenticity of the product.

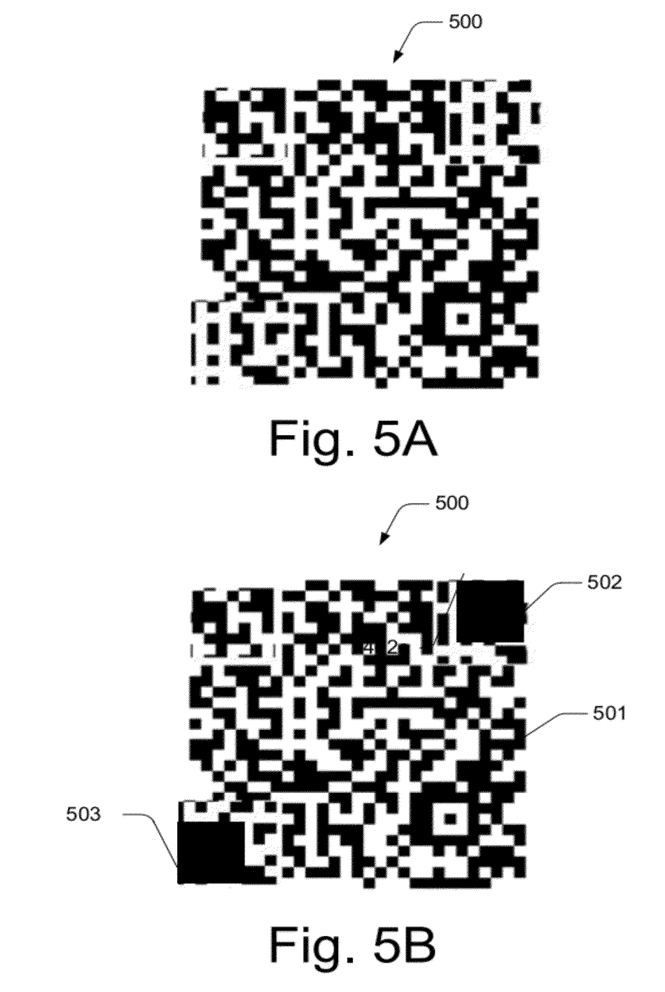

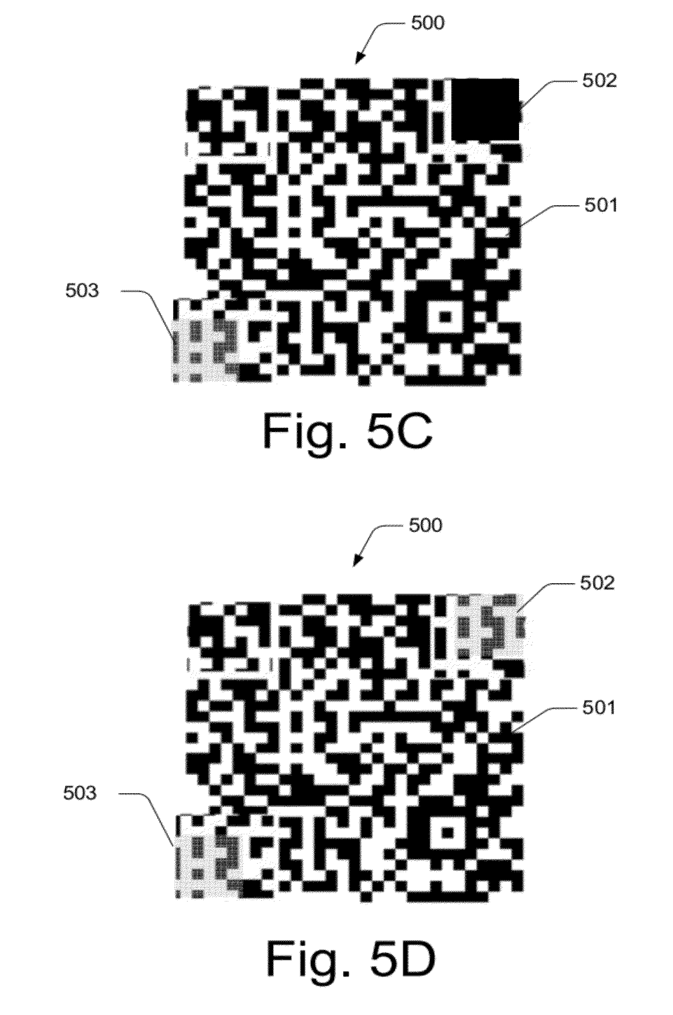

FIGS. 5A-5D show an exemplary anticounterfeiting code using a 2-D code. Except for the information coding scheme, the anti-counterfeiting method using a 2-D code is largely similar to that using a plain numerical code as shown in FIG. 3 and FIGS. 4A-4D.

FIG. 5A shows an exemplary 2-D code suitable for use in the anticounterfeiting method in accordance with the present description. 2-D code 500 is a typical two-dimensional matrix code containing encoded information. The amount of information that can be encoded into a 2-D code is much greater than a plain alphanumerical code or a 1D barcode, including not only product identification information but also additional information such as product description, and manufacturer's company information.

FIG. 5B shows the 2-D code 500 with the code information at two corner areas 502 and 503 concealed, leaving the code information in the remainder area 501 still visible.

FIG. 5C shows the 2-D code 500 with the code information at corner area 502 still concealed, but the corner area 503 revealed, leaving the code information in the corner area 503 plus that in the remainder area 501 visible. The combined code information in the two visible areas 501 and 503 can be used to conduct authenticity verification. For example, code in area 501 may be used as a product-identifying code, while the code in area 503 may be used as a confirmation code to verify the product-identifying code and authenticate the product. Alternatively, the combined code may be used as a single code to both identify and authenticate the product.

Because the information in the 2-D code 500 is encoded, it is not human-readable and requires an appropriate reader to read the information contained therein. Typically, the reader may have a scanner and a built-in decoder. Alternatively, the reader does not decode the information, but instead sends the information to the verification center to be decoded. Many mobile devices such as smart phones have or are going to have 2-D code reading capabilities.

FIG. 5D shows the 2-D code 500 with the code information at both corner areas 502 and 503 revealed, leaving the code information in the entire product code 500 visible. This may be done by a second authorized person by removing the concealment over the corner area 502. The second authorized person may use the combined code information in the entire product code 500 (including the three visible areas 501, 502 and 503) to conduct another authenticity verification.

It is noted that the overt code and the covert code(s) in accordance with the method disclosed herein may be mixed types of codes. For example, the overt code region 501 may have a 2-D code, while one or both of the covert code regions 502 and 503 may each have a plain alphanumerical code (not shown). The 2-D code in the overt code region 501 may be alone used for product identification, while the plain alphanumerical code in the covert code region 502 or 503 may be used together with the product identification provided by the 2-D code in the overt code region 501 for anti-counterfeiting. As discussed herein, even a very short alphanumerical code may effectively discourage would-be counterfeiters from making counterfeit products even if they have knowledge of the product-identifying code manifested in the 2-D code in the overt code region 501. A similar mixed-code type of implementation may also be used in 1D codes.

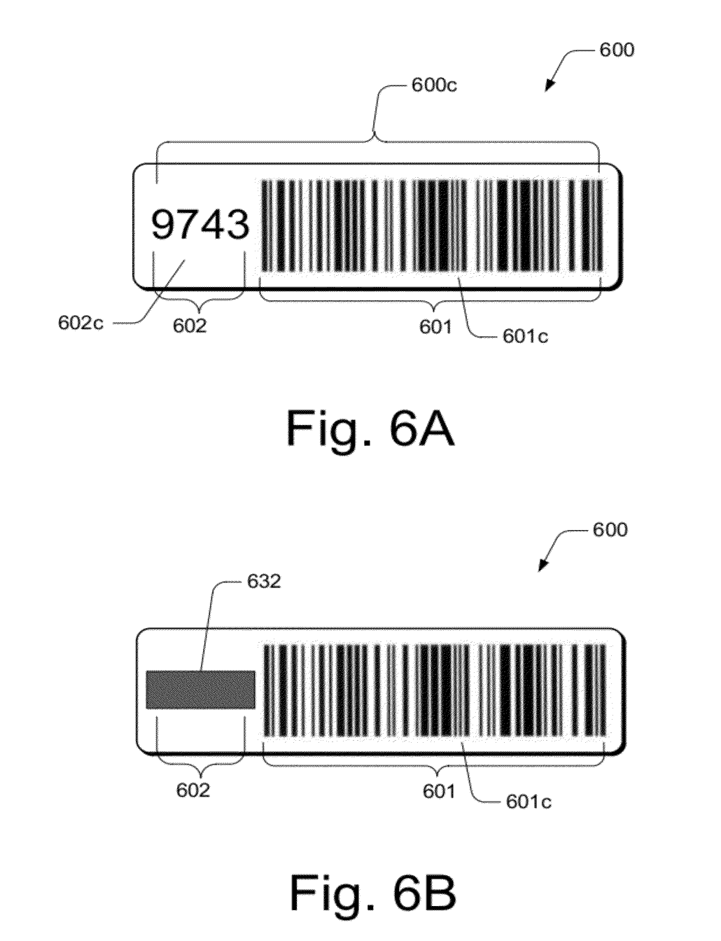

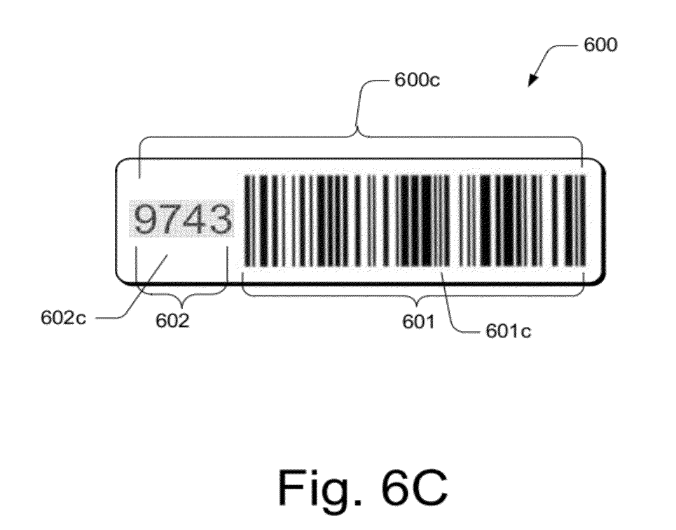

FIGS. 6A-6C show an exemplary anticounterfeiting code using a mix of a barcode and an alphanumerical code. Except for the information coding scheme, the anti-counterfeiting method using the mixed code is largely similar to that using a plain numerical code as shown in FIG. 1 and FIGS. 2A-2D.

FIG. 6A shows an exemplary mixed code suitable for use in the anticounterfeiting method in accordance with the present description. The mixed code 600 has a barcode 601c at the first code area 601, and a plain numeric code 602c in the second code area 602. The numeric code 602c is to be concealed. The barcode 601c can be read using a barcode scanner. The barcode 601c can be a typical barcode code containing encoded information.

FIG. 6B shows the mixed code 600 reproduced on the product to be authenticated. The numeric code 602c in the second code area 602 is concealed using a concealment (e.g., scratch-off material) 632. The barcode 601c is still uncovered and can be read using a barcode scanner.

FIG. 6C shows the mixed code 600 with the concealment 632 removed to reveal the numeric code 602c.

In the above embodiment, the barcode 601c alone may be used to identify the product. The level of identification may have a desired specificity such as an individual product item level. It can be used for product-identification purposes or even a limited anti-counterfeiting purpose even without the help of the additional numerical code 602c. The numerical code 602c is added to serve as a confirmation code to verify the product-identifying barcode 601c. When a verification system receives both the barcode 601c and the numerical code 602c, it may first use the barcode 601c to identify the product, and then use the product code record stored to check whether the received confirmation code 602c is correct. Ideally, only a specific number of confirmation codes are associated with each product-identifying code (barcode 601c) to offer certainty. For example, in the illustrated embodiment, the numeric code 602c may be the only confirmation code associated with the barcode 601c and accepted to verify it. As discussed herein, even a very short alphanumerical code may effectively discourage would-be counterfeiters from making counterfeit products even if they have knowledge of the product-identifying code manifested in the mixed code in the overt code region 601.

The embodiments described above illustratively show that the overt code and the covert code(s) are placed (e.g. printed) on the same layer of material, and the covert code(s) is covered by a separate layer of concealment material. However, it is noted that this type of implementation is only illustrative and not restrictive. In one embodiment, a product tag may have an overt code placed on a first layer of a code-bearing medium, and one or more covert codes placed on a second or third layer of code-bearing medium. The various layers of code-bearing medium may or may not be made of the same material. In this arrangement, instead of using a separate concealment material such as a scratch-off layer, at least a part of the first layer of code-bearing medium may be used as a means to cover the second or the third layer of code-bearing medium to conceal the covert code(s).

Furthermore, in the illustrated embodiments, the overt code and the covert code(s) are placed in different code regions and physically separated from each other. However, it is noted that this is only illustrative and not restrictive. It is possible to place both the overt code and the covert code(s) in the same area overlapping with each other, but readable by different means. As long as the following condition is satisfied, the anti-counterfeiting method described herein can be made effective: the covert code(s) cannot be easily revealed and reproduced on another product by an unauthorized party.

Exemplary embodiments are employed to illustrate the concept and implementation of the present invention in this disclosure. The exemplary embodiments are only used for better understanding of the method and core concepts of the present invention. Based on the concepts in this disclosure, a technician of ordinary skills in the art may make some modifications. These modifications should also be under the scope of the present invention.

1. An anti-counterfeiting method comprising:
associating a first code with a second code, the first code being designed to identify an article at a desired level of specificity, and the second code acting as a confirmation code to verify the first code;
reproducing the first code and the second code on or in the article, the first code being overt to normal viewing, and the second code being covert from normal viewing and is only conditionally revealed;
receiving the first code at a verification center;
identifying the second code associated with the received first code; and
allowing matching the identified second code with the second code conditionally revealed from the article for verifying the article's authenticity.

2. The anticounterfeiting method of claim 1, wherein allowing matching the identified second code with the second code conditionally revealed from the article comprises:
receiving the second code at a verification center after the second code has been revealed to an authorized person;
matching the received second code and the second code found in the article code records in association with the first code; and
sending a verification result to the authorized person.

3. The anticounterfeiting method of claim 1, wherein allowing matching the identified second code with the second code conditionally revealed from the article comprises:
sending the second code found in the article code records in association with the first code in response to receiving the first code such that an authorized person may compare the received second code with the second code revealed to the authorized person.

4. The anti-counterfeiting method of claim 1, wherein the second code reproduced on the article is covered by a layer of removable material.

5. The anti-counterfeiting method of claim 1, wherein the second code cannot be revealed to be reproduced on another article by an unauthorized party without performing an invasive act on the article.

6. The anti-counterfeiting method of claim 1, wherein the second code is significantly shorter than the first code and does not uniquely identify the article.

7. The anti-counterfeiting method of claim 1, wherein the second code is alphanumerical code having less than or equal to six alphanumerical positions.

8. The anti-counterfeiting method of claim 1, wherein the second code is a random number assigned to the first code.

9. The anti-counterfeiting method of claim 1, wherein the first code is a scannable barcode.

10. The anticounterfeiting method of claim 1, wherein the first code is a 2-D code.

11. The anti-counterfeiting method recited in claim 1, wherein the first code and the second code are reproduced on the article side-by-side.

12. The anti-counterfeiting method of claim 1, wherein reproducing the first code and the second code on or in the article comprises reproducing the first code and the second code on a tag affixed onto the article.

13. The anti-counterfeiting method of claim 1, wherein reproducing the first code and the second code on or in the article comprises reproducing the first code and the second code directly onto or in the article.

14. The anti-counterfeiting method of claim 1, wherein the article on which the first code and the second code are reproduced comprises a container containing goods therein.

15. The anti-counterfeiting method of claim 1, wherein the first code is received wirelessly from a mobile device.

16. The anti-counterfeiting method of claim 1, wherein the first code is received from a telephone by voice or through a keyboard.

17. The anti-counterfeiting method of claim 1, wherein the first code is received through an Internet user interface.

18. The anti-counterfeiting method of claim 1, wherein the first code is received through a mobile application user interface.

19. The anti-counterfeiting method recited in claim 1, further comprising:
associating a third code with the first code as an alternate confirmation code to verify the first code;
reproducing the third code on or in the article, the third code being covert from normal viewing and is only conditionally revealed;
receiving the first code at the verification center;
identifying the third code associated with the received first code; and
allowing matching the identified third code with the third code conditionally revealed from the article for verifying the article's authenticity.

20. The anti-counterfeiting method recited in claim 19, wherein, when reproduced on the article, the second code and the third code are clearly separated from each other.

21. An anti-counterfeiting method comprising:
associating a first code with an article, the first code being able to identify the article at a desired level of specificity;
associating a second code with the first code as a confirmation code to verify the first code;
reproducing the first code and the second code on or in the article, the first code being overt to normal viewing, and the second code being covert from normal viewing and is only conditionally revealed;
receiving the first code at a verification center;
receiving the second code at a verification center after the second code has been revealed to an authorized person;
comparing the received first code and the second code with article code records stored in the data storage; and
sending to the authorized person a verification result depending on whether the received first code and the second code find a match in a respective article code record stored in the data storage.

22. The anti-counterfeiting method of claim 21, wherein sending to the authorized person verification result comprises sending a text message to a mobile device of the authorized person.

23. An article used in anti-counterfeiting, the article comprising:
a first code region having an overt code which uniquely identifies the article or an item onto which the article is attached; and
a second code region having a covert code concealed from normal viewing by a concealment which is invasively removable to reveal the covert code and once removed cannot be easily restored to its original status, wherein the covert code is associated with the overt code as a confirmation code to verify the overt code.

24. The article of claim 23, wherein the second code region is smaller than the first region.

25. The article of claim 23, wherein the covert code is an alphanumerical code having one to six alphanumerical positions.

26. The article of claim 23, wherein the overt code is a two-dimensional code.

27. The article of claim 23 wherein the overt code is a barcode, while the covert code is an alphanumerical code.

28. The article of claim 23, further comprising:
a third code region having a second covert code concealed from normal viewing by a second concealment means which is invasively removable to reveal the second covert code and once removed cannot be easily restored to its original status, wherein the second covert code is associated with the overt code as an alternate confirmation code to verify the overt code.

29. The article of claim 28, wherein the second code region and the third code region are clearly separated from each other.

30. The anti-counterfeiting method of claim 1, further comprising:
identifying the product associated with the received first code at the verification center; and
sending information related to the identified product to an authorized person.
